(19) United States
(12) Patent Application Publication
(10) Pub. No.: US 2008/0096014 A1
(43) Pub. Date: Apr. 24, 2008

(54) Craze Resistant Plastic Article and Method of Production

(75) Inventors: Hans Griesser, South Australia (AU); Peter Murphy, South Australia (AU); Colin James Hall, South Australia (AU)

Correspondence Address: BIRCH STEWART KOLASCH & BIRCH, PO BOX 747, FALLS CHURCH, VA, 22040-0747, US

(73) Assignee: UNIVERSITY OF SOUTH AUSTRALIA, Adelaide (AU)

(21) Appl. No.: 11/792,951

(22) PCT Filed: Dec. 12, 2005
(86) PCT No.: PCT/AU05/01874

§ 371 Date: Oct. 4, 2007

(30) Foreign Application Priority Data
Dec. 13, 2004 (AU) 20044907060

(51) Int. Cl. C09D 5/00; C08J 7/04; C09D 7/14; C09D 183/00

(52) U.S. Cl. 428/336; 427/447; 428/446

(57) ABSTRACT

The present invention provides a process for producing a craze resistant plastic article. The process includes steps of exposing a substrate surface to a plasma gas formed by introducing a gas mixture containing oxygen and an organosilicon monomer into a plasma chamber to deposit a polymer coating that adheres to the surface of the substrate. An innermost region of the coating adjacent the surface of the substrate is deposited with a ratio of organosilicon monomer to oxygen in the gas mixture that is greater than or equal to 1. An outermost region of the coating is deposited with a ratio of organosilicon monomer to oxygen in the gas mixture that is less than 1. The ratio of organosilicon monomer to oxygen in the plasma gas is altered progressively over time between deposition of the innermost and outermost regions to form a graded coating.

This application claims priority from Australian patent application No. 2004907060 filed on 13 Dec. 2004, the contents of which are to be taken as incorporated herein by this reference.

### FIELD OF THE INVENTION

The present invention relates to a plastic article having a polymeric coating that reduces or prevents crazing of the article. The invention also relates to a process for producing a coated craze resistant article.

### BACKGROUND OF THE INVENTION

Crazing or craze cracking is a well known phenomenon that affects many plastic articles that are exposed to relatively harsh environmental conditions. Crazing of a plastic article is a result of the development of a multitude of very fine cracks, which gives the article a cloudy, cracked appearance. For many applications the crazing of an article is not particularly problematic. However, when the optical clarity of the plastic article is important, such as in plastic windows, signs, lamp covers, ophthalmic lenses and the like, crazing needs to be eliminated or minimized. Crazing may also be a problem in applications that require the article to be resistant to steady and impact loads.

Crazing may occur as a result of stress in an article or it may occur as a result of stress in combination with a particular environmental influence such as solvent vapour or moisture. Both types of crazing are common with rigid transparent thermoplastics such as polystyrene and poly(methyl methacrylate). The present application is concerned particularly with solvent related crazing. A number of mechanisms have been suggested to explain the development of solvent related crazing, and in most cases it is postulated that it results from small molecules such as water, solvents or surfactants penetrating the surface and surrounding portions of the polymer chains so as to reduce the forces required to separate the polymer chains. Tiny cracks then develop at a lower applied stress than in the absence of water, solvent or surfactant. In other cases, it has been postulated that water molecules and some other solutes can act as plasticizers, and that their rapid removal causes crazing as the polymer chains fail to relax.

One application in which crazing is particularly problematic is aircraft windows. Aircraft windows are made from a specific grade of stretched acrylic. Acrylic is susceptible to the absorption of water vapour (it has an equilibrium water content of approximately 2%) and this is a particular problem in the aviation industry, where an aircraft can be at ground level with a high ambient humidity and within a short time it can be at a relatively high altitude where it is exposed to significantly reduced humidity, pressures and temperature. Thus, the water molecules are pulled out of the acrylic, particularly in regions near the outer surface of the window. This cycling of humidity, pressure and temperature results in crazing of aircraft windows within a relatively short time frame. Indeed, windows in commercial aircraft are removed every 48 to 60 months so that they can be polished to restore optical clarity.

There have been a number of proposals for overcoming the problems associated with crazing of aircraft windows and other plastic articles. At present there are commercially available coatings for aircraft windows that are claimed to prevent the occurrence of crazing. However, there is a need for coated aircraft windows that are more durable in service than those that are currently available.

U.S. Pat. No. 6,514,573 (Hodgkin et al.) discloses a method for reducing crazing in a plastics material, such as an aircraft window. The method includes forming a polymer coating on an acrylic substrate surface by a plasma chemical vapour deposition (PCVD) process that involves exposing a surface of the substrate to a plasma containing a monomer vapour. However, it has been found that a coated substrate formed according to the disclosed process has poor abrasion resistance and poor durability in use.

U.S. Pat. No. 6,426,144 (Grünwald et al) discloses a method for coating a plastic substrate with an abrasion resistant coating. The coating that is disclosed also contains a UV absorbing compound. The chemical composition of the coating disclosed may not provide a coating with the durability required for applications such as aircraft windows.

The present invention aims to provide a coating for a plastic substrate that overcomes at least one of the problems associated with known coatings.

A reference herein to a patent document or other matter which is given as prior art is not to be taken as an admission that that document or matter was known or that the information it contains was part of the common general knowledge in any country as at the priority date of any of the claims of this application.

### SUMMARY OF THE INVENTION

The present invention provides a craze resistant plastic article including a plastic substrate and a polymer coating on a surface of the substrate, wherein the coating has a silicon content of 21 to 31 atomic percent, an oxygen content of 28 to 38 atomic percent, and a carbon content of 36 to 46 atomic percent in an innermost region of the coating that is adjacent the substrate surface, and a silicon content of 24 to 42 atomic percent, an oxygen content of 32 to 60 atomic percent, and a carbon content of 8 to 36 atomic percent at an outermost region of the coating that is adjacent the surface of the coating, and a compositional gradient between the innermost and outermost regions.

As used herein atomic percentages are exclusive of the amount of hydrogen or other non-specified elements present in the composition of the coating unless otherwise specified. Atomic percentages of elements in the innermost, outermost or any other region of the coating can be determined by XPS. XPS measurements have an error range of ±2 atomic percent. Atomic percentages expressed herein do not include this error range.

The coating may also contain a middle region between the innermost and outermost regions, with the composition of the middle region having a silicon content of 22 to 32 atomic percent, an oxygen content of 33 to 43 atomic percent, and a carbon content of 30 to 40 atomic percent. In this embodiment of the invention the coating may have a compositional gradient between the innermost and middle regions as well as between the middle and outermost regions.

The coating is most preferably formed on the substrate by means of plasma polymerisation. Thus, the substrate may be held in a plasma reaction chamber containing oxygen as a working gas and a feed gas mixture containing a silicon monomer may be fed into the chamber to form a plasma gas containing the silicon monomer and oxygen. The innermost region of the coating will be deposited first and the graded coating may then be formed by altering the ratio of a silicon monomer and oxygen in the plasma over time. Thus, as the coating layer is deposited there is graded change in the composition of the coating as it builds up over time. The coating of the present invention may provide for improved craze resistance through the dissipation of stresses that may otherwise crack the coating. The coated substrate may also have improved durability relative to prior art coated substrates.

In one specific embodiment of the invention, the coating has the following composition:

| | Silicon | Oxygen | Carbon |
|---|---|---|---|
| | (atomic | (atomic | (atomic |
| | percent) | percent) | percent) |
| Innermost region | about 25 | about 34 | about 41 |
| Middle region | about 27 | about 37 | about 37 |
| Outermost region | about 26 | about 48 | about 26 |

The coating of this specific embodiment may be produced using plasma deposition conditions described herein and with a constant silane monomer gas flow of 150 sccm and an oxygen gas flow of 100 sccm during deposition of the innermost region of the coating, an oxygen gas flow of 300 sccm during deposition of the middle region of the coating, and an oxygen gas flow of 500 sccm during deposition of the outermost region of the coating.

Optionally, multilayer coatings may be provided. A multilayer coating may be a coating which has two or more consecutive layers or regions in which the composition varies from an innermost region that is relatively rich in carbon, to an outermost region that is richer in silicon and oxygen and poorer in carbon than the innermost region. At least one of the two or more layers or regions preferably has a continuously graded chemical composition between the innermost and the outermost region.

The outermost region may also have a compositional gradient such that the carbon content increases towards the surface and the oxygen and silicon composition decreases. This is opposite to that of the bulk of the coating which begins with high carbon content (at the interface with the substrate) and decreases towards the surface of the coating.

The coating could also be overcoated with a topcoat in order to confer additional desirable properties. The topcoat may be applied by plasma polymerization by switching process vapours or by other coating methods that are known in the art. For example, the topcoat could be a fluoropolymer which increases the hydrophobicity of the coating.

The present invention also provides a process for producing a craze resistant plastic article, the process including:
providing a plastic substrate suitable for coating;
activating a surface of the substrate;
exposing the substrate surface to a plasma gas formed by introducing oxygen and an organosilicon monomer into a plasma chamber to deposit a polymer coating that adheres to the surface of the substrate, wherein an innermost region of the coating adjacent the surface of the substrate is deposited with a ratio of organosilicon monomer to oxygen in the plasma gas that is greater than or equal to 1, and an outermost region of the coating is deposited with a ratio of organosilicon monomer to oxygen in the plasma gas that is less than 1; and
the ratio of organosilicon monomer to oxygen in the plasma gas is decreased progressively over time between deposition of the innermost and outermost regions to form a graded coating.

Preferably the process is carried out using a plasma which is activated by microwaves. In this way the plasma may be formed remotely from the substrate that is being coated and it is not in the direct vicinity of the plastic substrate. Thus, the substrate is coated indirectly.

The present invention also provides a craze resistant coated plastic article that is formed according to the aforementioned process. In addition, the present invention also provides coating for use in producing a craze resistant plastic article, wherein the coating is formed according to the aforementioned process.

The present invention also provides a craze resistant plastic article including a plastic substrate and a polymer coating on a surface of the substrate, wherein the coating has an innermost region that is adjacent the substrate surface having a composition of SiO_{0.9-1.8}C_{1.2-2.2}, and an outermost region of the coating that is adjacent the surface of the coating having a composition of SiO_{1-5-2.5}C_{0.2-1.5} and a compositional gradient between the innermost and outermost regions.

In one particularly preferred form of the invention the plastic article is an aircraft window.

### GENERAL DESCRIPTION OF THE INVENTION

Various terms that will be used throughout this specification have meanings that will be well understood by a skilled addressee. However, for ease of reference, some of these terms will now be defined.

The term “plasma gas” as used throughout the specification is to be understood to mean a gas (or cloud) of charged and neutral particles exhibiting collective behaviour which is formed by excitation of a source of gas or vapour. A plasma gas containing a silicon compound contains many chemically active charged and neutral species which react with the surface of the substrate. Typically, plasma gases are formed in a plasma chamber wherein a substrate is placed into the chamber and the plasma gases are formed around the substrate using a suitable radiofrequency or microwave frequency, voltage and current.

The term “compositional gradient” as used throughout the specification in relation to the composition of the coating is to be understood to mean that there is an increase or decrease in the atomic percentage of at least one element in the composition as the coating is deposited. In the coated end product this means that the atomic percentage of at least one element in the coating composition increases or decreases as one moves through the coating away from the substrate. The compositional gradient may be a continuous gradient which means that the atomic percentage of at least one of the elements of the coating composition changes in an uninterrupted manner as the composition is deposited. The compositional gradient may also be a discontinuous gradient which means that the atomic percentage of at least one of the elements of the coating composition may increase or decrease overall as the coating is deposited, but there may be interruptions in the gradient. The compositional gradient of a coating may be determined using XPS.

The term “craze resistant” as used throughout the specification in relation to a plastic article is to be understood to mean that very fine cracks that are characteristic of crazing do not form in the substrate under normal conditions of usage relative to an uncoated article under equivalent conditions. For example, in the case of an aircraft window the article may be considered craze resistant if the formation of very fine cracks that are characteristic of crazing does not occur during normal aircraft operations for a period of time that is greater than the time period after which an uncoated window crazes. Craze resistance may result from a coating preventing ingress of moisture or other small molecules into the surface of the substrate. However, there are other interrelated factors that collectively confer craze resistance on an article. For example, a coating must also have a sufficient degree of mechanical compliance with the substrate. Again in the case of an aircraft window, the window flexes during use of the aircraft and therefore a coating that is too stiff may increase the stress on the article, which in turn could contribute to crazing.

Turning now to a description of the invention in more detail.

The present invention provides a craze resistant plastic article including a plastic substrate and a polymer coating on a surface of the substrate, wherein the coating has a silicon content of 21 to 31 atomic percent, an oxygen content of 28 to 38 atomic percent, and a carbon content of 36 to 46 atomic percent in an innermost region of the coating that is adjacent the substrate surface, and a silicon content of 24 to 42 atomic percent, an oxygen content of 32 to 60 atomic percent, and a carbon content of 8 to 36 atomic percent at an outermost region of the coating that is adjacent the surface of the coating, and a continuous or discontinuous compositional gradient between the innermost and outermost regions.

Preferably, the coating has a silicon content of 24 to 28 atomic percent, an oxygen content of 32 to 36 atomic percent, and a carbon content of 39 to 43 atomic percent in the innermost region of the coating, a silicon content of 31 to 35 atomic percent, an oxygen content of 39 to 43 atomic percent and a carbon content of 25 to 29 atomic percent at the outermost region of the coating.

The coating may also contain a middle region between the innermost and outermost regions, with the composition of the middle region having a silicon content of 22 to 32 atomic percent, an oxygen content of 33 to 43 atomic percent, and a carbon content of 30 to 40 atomic percent, and a compositional gradient between the innermost and middle regions as well as between the middle and outermost regions. Most preferably, the middle region has a silicon content of 25 to 29 atomic percent, an oxygen content of 36 to 40 atomic percent, and a carbon content of 33 to 39 atomic percent.

The nature of the polymer coating is such that it is highly transparent (92%) in the visible region of the electromagnetic spectrum. The nature of the coating is also such that the coated article is substantially haze free (i.e. with a haze of less than 2%).

The craze resistant plastic article is produced using a process including:
providing a plastic substrate suitable for coating;
activating the substrate surface;
exposing the substrate surface to a plasma gas formed by introducing oxygen and an organosilicon monomer into a plasma chamber to deposit a polymer coating that adheres to the substrate on the surface of the substrate, wherein the ratio of organosilicon monomer to oxygen in the plasma gas is greater than or equal to 1; and
decreasing the ratio of silicon monomer to oxygen in the plasma gas to less than 1 over time whilst the coating is being deposited to form a graded coating on the surface of the substrate.

Plasma assisted chemical vapour deposition (“PACVD” or “PCVD” or “plasma coating”) is a preferred method for forming the coatings described herein, principally because the technique is particularly amenable to the formation of graded coatings. However, it is envisaged that other coating processes that are known in the art may also be used.

The process of the present invention provides a graded coating on the plastic substrate that confers improved protection against crazing. The carbon and silicon content of the coating in the innermost region that is adjacent the surface of the substrate is higher than it is at the outermost region of the coating that is adjacent the surface of the coating. Without intending to be bound by one particular theory as to the reason for the improved performance of the coating of the invention it is postulated that the higher carbon content of the coating adjacent the surface of the substrate provides for improved adhesion and mechanical compliance of the coating with the substrate, whereas the lower carbon and higher silicon and oxygen content of the coating at the outer surface provides a more effective barrier that is relatively resistant to the ingress of moisture. Additional mechanical compliance may also result from a closer match of thermal expansion coefficients of the substrate and the inner most region of the coating. Furthermore, a lack of clearly defined compositional boundaries in the coating may decrease the possibility of de-lamination of the coating along compositional boundaries.

In the process of the present invention a plasma chamber is equipped with a microwave plasma source formed from a number of individual microwave source rods with a total output each of 0.5 to 10 kW. The oxygen and silicon monomer gases required for the plasma process are introduced into the chamber through gas feeding pipes equipped with mass flow controllers. The oxygen is introduced into the plasma chamber as the working gas, whilst a gas feeding pipe introduces the silicon monomer downstream of the microwave plasma source turned toward the plastic substrate. The plasma chamber is evacuated constantly with a vacuum pump.

The plastic substrate to be coated is fastened to a holding device in such a way that the side of the substrate to be coated is turned toward the microwave source during the coating process. After fitting the substrate in to the holding device a loading door is locked and the chamber is evacuated with the help of a vacuum pump.

In the process of the present invention the substrate is held within the plasma chamber and is surrounded by plasma gas containing oxygen and the organosilicon monomer. Advantageously, the plasma gas treatment is an indirect treatment which means that relatively complex shapes or curved substrates can be effectively coated.

The plastic substrate to be coated may be any article in need of a coating to reduce or prevent crazing. The article may be transparent or non-transparent. For example, the article may be a vehicle window, an aircraft window, plastic panels for buildings, and plastic light fittings. The process of the present invention may be used to coat a wide variety of plastics, including (but not limited to) acrylic, stretched acrylic, polystyrene, polycarbonate, polyethylene-terephthalate, polyvinylchloride, polyamide (such as nylon), or any other plastic which is prone to crazing. The coating will normally be applied to a surface of the substrate that is exposed to the environment during normal usage. In the case of an aircraft window the coated surface will be the exterior surface when the window is fitted to the aircraft. However, it may also be desirable to coat both sides of an article such as an aircraft window. The coating of more than one surface may be carried out in a stepwise manner or all surfaces may be coated simultaneously.

The substrate surface to be coated is activated prior to coating. Firstly, it is desirable to remove surface impurities from the surface of the substrate prior to exposing it to the plasma gas containing oxygen and the organosilicon monomer. The surface impurities may be removed using any suitable method, although preferably the surface impurities are removed by wiping the surface of the substrate with a suitable solvent. The surface may be further cleaned by ultrasonic methods that are known to a person skilled in the art. The surface may then be activated by exposing it to a plasma gas, for example dry air, an inert plasma gas or by applying a thin primer layer by plasma polymerization.

Activation of the surface of the substrate preferably includes a step of exposing the substrate to a plasma gas containing a lower alcohol to form a relatively thin polymeric layer that has a hydrocarbon backbone and polar side groups such as hydroxyl groups on the substrate surface prior to deposition of the coating. The primary role of this layer is to promote adhesion between the substrate and the coating. As such, this layer may act as a primer layer, the chemical composition of which is different to that of the coating layer. Suitable lower alcohols that can be used to form a primer layer include alcohols with alkyl groups having between 1 and 10 carbon atoms, more preferably 1 to 5 carbon atoms. Methanol, ethanol, n-propanol and isopropyl alcohol are preferred alcohols, with isopropyl alcohol being the most preferred.

The organosilicon monomer that is included in the plasma gas may be any agent that is able to form an organosilicon based polymer coating on the surface of the substrate. The organosilicon monomer is preferably a hexa- or tetra-alkylorganosilane containing alkyl groups having between 1 and 10 carbon atoms, more preferably 1 to 5 carbon atoms. Preferred organosilicon monomers include tetramethyldisiloxane, hexamethyldisiloxane tetrapropoxysilane, tetraethoxysilane, tetramethoxysilane and vinyltrimethylsiloxane. In a particularly preferred form of the invention the organosilicon monomer is tetramethyldisiloxane.

It may be advantageous to preheat the substrate surface to achieve faster cycle time and enhance some characteristics of the coating, for example thermal stability. Further to this, it may be necessary to control the substrate temperature so that it remains between about 40° C. and about 150° C. (depending on the substrate) both before, during and after the deposition process. In the case of stretched acrylic, the surface of the substrate is preferably heated up to about 120° C.

The rate and/or extent of reaction of the plasma gas containing oxygen and the organosilicon monomer and the substrate can be controlled by controlling one or more of the plasma feed composition, the composition of the substrate, gas pressure, plasma power, voltage and process time.

Preferably the substrate is exposed to the plasma in a plasma chamber held at between 0.02 Torr to 0.75 Torr, preferably about 0.4 Torr. It will be appreciated that the range of suitable working pressures in the plasma chamber is a function of the design of the plasma and chamber geometry and could be extended using high vacuum plasma chambers

In one preferred form of the invention the deposition conditions for the coating are as follows:
Deposition time=120 seconds
Deposition pressure=0.3 to 0.45 Torr
Silicon monomer flow=150 sccm
Oxygen Ramp
   100 sccm for 10 seconds
   100 to 500 sccm for 20 seconds
   500 sccm for 90 seconds
Microwave Power=4 to 6 kW

Thus, the organosilicon monomer:oxygen ratio is 3:2 initially and it is altered over a time period of 20 seconds to 3:10. Thus, the innermost region is deposited with an organosilicon monomer:oxygen ratio of 3:2 and the outermost region is deposited with an organosilicon monomer:oxygen ratio of 3:10.

Using the methods of the present invention the coatings generally have a thickness of about 100 nm to about 50,000 nm, more preferably about 500 nm to about 10,000 nm, and most preferably about 2000 to about 4000 nm. The thickness of the coating overall, as well as the relative thickness of the innermost, middle and outermost regions of the coating can be controlled by controlling the amount of time the substrate is exposed to a plasma gas having a particular ratio of oxygen and silicon monomer. It may be preferred that the outermost region is relatively thick compared to the innermost region.

The coating may be a single layer coating having a continuous or discontinuous compositional gradient. Alternatively, the coating may be a multilayer coating that is formed by depositing silicone-like coatings by plasma polymerisation in consecutive stages. In the case of a multilayer coating at least one of the layers will have a continuously graded chemical composition with an outermost region that is richer in silicon and oxygen and poorer in carbon than the innermost region. Multilayer coatings may be formed by consecutive, distinct plasma deposition steps using a plasma gas containing an organosilicon monomer and oxygen as described herein.

A multi-layer coating structure in which the coating has a composition which varies a number of times may provide benefits in performance. More specifically, the coating may have the following composition:
(a) a silicon content of 21 atomic percent to 31 atomic percent, an oxygen content of 28 atomic percent to 38 atomic percent, and a carbon content of 36 atomic percent to 46 atomic percent in the innermost region of the coating that is adjacent the substrate surface;
(b) a silicon content of 24 atomic percent to 42 atomic percent, an oxygen content of 32 atomic percent to 60 atomic percent, and a carbon content of 8 atomic percent to 36 atomic percent in a second layer adjacent the innermost region;
(c) a silicon content of 21 atomic percent to 31 atomic percent, an oxygen content of 28 atomic percent to 38 atomic percent, and a carbon content of 36 atomic percent to 46 atomic percent in a third layer adjacent the second layer;
(d) a silicon content of 24 atomic percent to 42 atomic percent, an oxygen content of 32 atomic percent to 60 atomic percent, and a carbon content of 8 atomic percent to 36 atomic percent in the outermost region of the coating; and
(e) a compositional gradient between respective regions and layers.

The outermost region can have a compositional gradient such that the silicon and oxygen content of the outermost region decreases and the carbon content increases towards the surface of the coating. This is opposite to that of the bulk of the coating which begins with high carbon content (at the interface) and decreases towards the surface.

The coating may be overcoated with a topcoat in order to confer additional desirable properties on the coating and hence the substrate. Any additional topcoat may be applied by plasma polymerisation by switching process vapours. Alternatively, the topcoat may be applied using traditional solution coating techniques, including (but not limited to) spin coating, dip coating, spray coating, and flow coating.

The top coat may be a hydrophobic topcoat, a hydrophilic topcoat, a diamond like carbon topcoat, an oleophobic topcoat, a metal oxide (for example SiO₂, TiO₂) topcoat that is formed via sputtering or physical vapour deposition, or a slip coating with very low coefficient of friction, which would be beneficial for an aircraft window. The top coat could also be a combination of two or more of these coatings.

In one embodiment of the invention the topcoat is a fluoropolymer which provides hydrophobicity to the surface of the coating. The fluoropolymer topcoat may be deposited by plasma deposition or by solution coating using a fluorocarbon monomer. Suitable fluorocarbon monomers that can be used in the include any one of the range of perfluorinated compounds that are known for that purpose including, but not limited to, tetrafluoromethane, hexafluoroethane, tetrafluoroethylene, perfluorobutylene, perfluorocyclopentane and perfluorocyclohexane. Preferably, the fluoropolymer is deposited by plasma deposition.

### DESCRIPTION OF EMBODIMENTS OF THE INVENTION

Preferred embodiments of the invention will now be described by way of the following non-limiting examples.

### Example 1

### Coating Process

Substrate Preparation

The substrate is cleaned using iso-propyl alcohol and a tissue. It is then loaded into the vacuum chamber (it maybe advantageous to warm the substrate surface) and the chamber is evacuated to below 7×10⁻⁴ Torr.

Deposition

A primer layer is applied by plasma deposition using an iso-propyl alcohol feed gas over a 100 second period, with a short pause before the application of the barrier layer over a 130 second period. Process parameters which take place for the deposition of the primer layer and the graded coating are as follows.

Primer Layer

Gas stabilization time=10 seconds

Gas stabilization pressure=0.006 Torr

Feed Pressure=25 torr

Iso-propyl Alcohol flow=75 sccm

Deposition time=90 seconds

Deposition pressure=0.14 Torr

Microwave power=5.4 kW

Substrate temperature=60° C. (maximum)

Barrier Layer

Gas stabilization time=10 seconds

Gas stabilization pressure=0.23 Torr

Feed Pressure=110 torr

Deposition time=120 seconds

Deposition pressure=0.3 to 0.45 Torr

TMDS flow=150 sccm

Oxygen Ramp

100 scorn for 10 seconds
100 to 300 scorn for 20 seconds
300 scorn for 90 seconds
   Microwave Power=5.4 kW
   Substrate Temperature=85° C. (maximum)
   Coating Thickness=3 microns

On completion of the deposition process the chamber is vented to atmospheric pressure and the substrate removed and allow to cool. Final coating properties may take up to 24 hours to develop as the coatings can age.

It is advantageous to minimise the reflected power from the microwave generation system. This is to achieve the maximum power transfer to the plasma. To that effect, the microwave generation system is tuned during a setup stage, so that the reflected power is less than 10% of the forward power.

### Example 2

### Chemical Characterisation of the Coating

A coated acrylic substrate prepared in accordance with Example 1 had the following composition as determined by XPS analysis:

| | Silicon | Oxygen | Carbon |
|---|---|---|---|
| | (atomic | (atomic | (atomic |
| | percent) | percent) | percent) |
| Innermost region | about 26 | about 34 | about 41 |
| Middle region | about 27 | about 38 | about 35 |
| Outermost region | about 33 | about 41 | about 27 |

The most accurate method for determining coating composition (atomic percentage) is via XPS analysis. Other techniques that are used to characterise the chemical properties of the coating include: scanning electron microscopy (SEM), transmission electron microscopy (TEM), time of flight secondary ion mass spectrometry (TOF-SIMS), and Fourier transform infrared spectroscopy (FTIR).

### Example 3

### Physical Testing of the Coating

3.1 Acid Bend Test

This tests the coatings sensitivity for stress crazing in an acid environment. It shows the barrier efficiency of coating against acid. This test is based on ASTM F484 and differs in some aspects.

The specimen is put under stress (6000 psi) whilst a fibreglass cloth which is soaked in sulphuric acid is laid across coating surface.

The evaluation is determined from:—

Extent and length of crazing after certain time

Stress to Craze, S=6LP/wt² in psi.

where

L is the length which remains craze free after 4 hours.
w is the width
t is the thickness
P is the load applied

Out testing showed that commercial coatings (Crystal Vue II and Solgard) can remain craze free for 24 hours and maintain a “Stress to Craze” of 6000 psi. We achieved the same results with a coated substrate that was prepared according to Example 1.

| | Stress to Craze |
|---|---|
| | (psi) |
| Coated substrate according to Example 1 | 6000 |
| Commercial Coating 1 | 6000 |
| (CrystalVue II ™ by GKN Aerospace) | |
| Commercial Coating 2 | 5100 |
| (Solgard ™ by PPG Industries) | |
| Coated substrate prepared according | 6000 |
| to U.S. Pat. No. 6,514,573 | |

3.2 Mechanical Characterisation

Through nanoindentation, the mechanical characteristics of thin films can be determined. In this test, the innermost region was deposited onto an acrylic substrate (as measurements can be effect by the substrate) as set out in Example 1 and the nanoindentation was measured. ISO 14577 describes the procedure followed. The outermost region was deposited and characterised in the same way. These mechanical characteristics correlate with the chemical composition as described earlier. The high carbon, low Si, O₂ give a softer coating where as a low carbon, high Si, O₂ give a harder coating

| | | Young's Modulus |
|---|---|---|
| | Hardness (GPa) | (GPa) |
| Innermost Region | 0.4 ± 0.1 | 3.5 ± 0.5 |
| Outermost Region | 0.8 ± 0.5 | 7.3 ± 0.5 |

The mechanical properties of a variety of commercial samples are shown below.

| | | Young's Modulus |
|---|---|---|
| | Hardness (GPa) | (GPa) |
| Commercial Coating 1 | 0.34 ± 0.1 | 4.3 ± 1.3 |
| (CrystalVue II ™ by | | |
| GKN Aerospace) | | |
| Commercial Coating 2 | 0.42 ± 0.1 | 4.0 ± 0.5 |
| (Solgard ™ by PPG | | |
| Industries) | | |

### Example 4

### Alternative Coating Process

A variation to the coating process of Example 1 is provided below.

Substrate Preparation

The substrate is cleaned using iso-propyl alcohol and a tissue. It is then loaded into the vacuum chamber (it maybe advantageous to warm the substrate) and the chamber is evacuated to below 7×10⁻⁴ Torr.

Deposition

A primer layer is applied over a 100 second period, with a short pause before the application of the barrier layer over a 130 second period. Process parameters which take place for the deposition of the primer layer and the graded coating are;

Primer Layer

Gas stabilization time=10 seconds

Gas stabilization pressure=0.006 Torr

Feed Pressure=25 torr

Iso-propyl Alcohol flow=75 sccm

Deposition time=90 seconds

Deposition pressure=0.14 Torr

Microwave power=6 kW

Substrate temperature=90° C. (maximum)

Barrier Layer

Gas stabilization time=10 seconds

Gas stabilization pressure=0.23 Torr

Feed Pressure=110 torr

Deposition time=120 seconds

Deposition pressure=0.3 to 0.6 Torr

TMDS flow=150 sccm

Oxygen Ramp

100 sccm for 10 seconds
100 to 500 sccm for 20 seconds
500 sccm for 90 seconds
   Microwave Power=6 kW
   Substrate Temperature=140° C. (maximum)
   Coating Thickness=3 microns

On completion of the deposition process the chamber is vented to atmospheric pressure and the substrate removed and allow to cool. Final coating properties may take up to 24 hours to develop as the coatings can age.

The compositional data for the coating are as follows:

| | Silicon | Oxygen | Carbon |
|---|---|---|---|
| | (atomic | (atomic | (atomic |
| | percent) | percent) | percent) |
| Innermost region | about 25 | about 34 | about 41 |
| Middle region | about 26 | about 37 | about 37 |
| Outermost region | about 26 | about 48 | about 26 |

### Example 5

### Physical Testing of the Coating

5.1 Steel Wool Abrasion Resistance Test

In this test, a steel wool pad (ABC brand, Grade ‘0’) is moved with a certain number of strokes (75) and pressure (1.6 psi) over the test specimen. The steel wool abrasion ratio is calculated from the difference of haze (DH [%]) measured on a coated and an uncoated sample after 75 strokes. The value of DH is the difference of initial and final haze value. Also a visual rating can be used.

On testing, we found that a coated substrate formed in accordance with Example 4 has an abrasion ratio greater than 10 times that of an uncoated substrate.

Testing has shown that some commercial coatings have an abrasion ratio greater than 10 times that of an uncoated sample. Notably, the coating described in U.S. Pat. No. 6,514,573 (Hodgkin et al) displayed the same abrasion resistance as to that of the uncoated substrate.

| | Steelwool |
|---|---|
| | Abrasion Ratio |
| Coated substrate according to Example 4 | >10 |
| Commercial Coating 1 | >10 |
| (CrystalVue II ™ by GKN Aerospace) | |
| Commercial Coating 2 | 7 |
| (Solgard ™ by PPG Industries) | |
| Coated substrate prepared according | 1 |
| to U.S. Pat. No. 6,514,573 | |

3.3 Bayer Abrasion Test

The Bayer Abrasion test is a test of the resistance of a coating to abrasion through the oscillation of abrasive media across the surface. The test method is based on ASTM F735 “Standard test method for abrasion resistance of transparent plastics and coatings, using the oscillating sand method”

Samples are held in the bottom of a tray and 0.5 kg of Alundum (Aluminium Zirconium Oxide:—grid size 12) is added. The tray is cycled back and forth 300 times. The Bayer Abrasion Ratio is calculated from the difference of haze (DH [%]) measured on a coated and an uncoated sample after the test. The value DH is the difference of initial and final haze values.

| | Bayer |
|---|---|
| | Abrasion Ratio |
| Coated substrate according to Example 4 | 5 ± 1 |
| Commercial Coating 1 | 3 ± 0.7 |
| (CrystalVue II ™ by GKN Aerospace) | |
| Commercial Coating 2 | 4 ± 0.8 |
| (Solgard ™ by PPG Industries) | |

### Example 6

### Multilayer Coatings

A variation to the coating process which gives good results is a multi-layer/multi-region coating. A coating having 4 layers/regions with varying oxygen flow i.e 300 sccm/500 sccm/300 sccm/500 sccm was prepared. The process is not stopped between oxygen flow settings, so that no distinct layers are formed. The composition swaps, twice, between high carbon/low oxygen content and low carbon/high oxygen content. This also corresponds to a change in mechanical characteristics, with the following transitions soft-hard-soft-hard.

Substrate Preparation

The substrate is cleaned using iso-propyl alcohol and a tissue. It is then loaded into the vacuum chamber (it maybe advantageous to warm the substrate) and the chamber is evacuated to below 7×10⁻⁴ Torr.

Deposition

A primer layer is applied over a 100 second period, with a short pause before the application of the barrier layer over a 130 second period. Process parameters which take place for the deposition of the primer layer and the graded coating are

Primer Layer

Gas stabilization time=10 seconds

Gas stabilization pressure=0.006 Torr

Feed Pressure=25 torr

Iso-propyl Alcohol flow=75 sccm

Deposition time=90 seconds

Deposition pressure=0.14 Torr

Microwave power=6 kW

Substrate temperature=90° C. (maximum)

Barrier Layer

Gas stabilization time=10 seconds

Gas stabilization pressure=0.23 Torr

Feed Pressure=110 torr

Deposition time=120 seconds

Deposition pressure=0.3 to 0.6 Torr

TMDS flow=150 sccm

Oxygen Ramp

300 sccm for 30 seconds

500 sccm for 30 seconds

300 sccm for 30 seconds

500 sccm for 30 seconds

Microwave Power=6 kW

Substrate Temperature=140° C. (maximum)

Coating Thickness=3 microns

On completion of the deposition process the chamber is vented to atmospheric pressure and the substrate removed and allow to cool. Final coating properties may take up to 24 hours to develop as the coatings can age.

The compositional data for the coating are as follows:

| Oxygen | | | |
|---|---|---|---|
| Flow(sccm) | Silicon | Oxygen | Carbon |
| 300 | 26 | 37 | 37 |
| 500 | 26 | 46 | 28 |

Finally, it will be appreciated that various modifications and variations of the methods and articles of the invention described herein will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the present invention.

1. A craze resistant plastic article including a plastic substrate and a polymer coating on a surface of the substrate, wherein the coating has a silicon content of 21 to 31 atomic percent, an oxygen content of 28 to 38 atomic percent, and a carbon content of 36 to 46 atomic percent in an innermost region of the coating that is adjacent the substrate surface, and a silicon content of 24 to 42 atomic percent, an oxygen content of 32 to 60 atomic percent, and a carbon content of 8 to 36 atomic percent at an outermost region of the coating that is adjacent the surface of the coating, and a compositional gradient between the innermost and outermost regions.

2. (canceled)

3. A craze resistant plastic article according to claim 1, wherein the innermost region of the coating has a silicon content of 24 to 28 atomic percent, an oxygen content of 32 to 36 atomic percent, and a carbon content of 39 to 43 atomic percent, and the outermost region of the coating has a silicon content of 24 to 30 atomic percent, an oxygen content of 44 to 52 atomic percent, and a carbon content of 22 to 30 atomic percent.

4. A craze resistant plastic article according to claim 1, wherein the coating also contains a middle region between the innermost and outermost regions, with the composition of the middle region having a silicon content of 22 to 32 atomic percent, an oxygen content of 33 to 43 atomic percent, and a carbon content of 30 to 40 atomic percent, and a compositional gradient between the innermost and middle regions as well as between the middle and outermost regions.

5. (canceled)

6. A craze resistant plastic substrate according to claim 1, wherein the innermost region of the coating has a silicon content of about 25 atomic percent, an oxygen content of about 34 atomic percent, and a carbon content of about 41 atomic percent, and the middle region has a silicon content of about 26 atomic percent, an oxygen content of about 37 atomic percent, and a carbon content of about 37 atomic percent, and the outermost region of the coating has a silicon content of about 26 atomic percent, an oxygen content of about 48 atomic percent, and a carbon content of about 26 atomic percent.

7. A craze resistant plastic article according to claim 1, wherein the coating has the following composition:
(a) a silicon content of 21 atomic percent to 31 atomic percent, an oxygen content of 28 atomic percent to 38 atomic percent, and a carbon content of 36 atomic percent to 46 atomic percent in the innermost region of the coating that is adjacent the substrate surface;
(b) a silicon content of 24 atomic percent to 42 atomic percent, an oxygen content of 32 atomic percent to 60 atomic percent, and a carbon content of 8 atomic percent to 36 atomic percent in a second layer adjacent the innermost region;
(c) a silicon content of 21 atomic percent to 31 atomic percent, an oxygen content of 28 atomic percent to 38 atomic percent, and a carbon content of 36 atomic percent to 46 atomic percent in a third layer adjacent the second layer;
(d) a silicon content of 24 atomic percent to 42 atomic percent, an oxygen content of 32 atomic percent to 60 atomic percent, and a carbon content of 8 atomic percent to 36 atomic percent in the outermost region of the coating; and
(e) a compositional gradient between respective regions and layers.

8. (canceled)

9. (canceled)

10. (canceled)

11. (canceled)

12. (canceled)

13. A craze resistant plastic article according to claim 1, wherein the outermost region has a compositional gradient in which the silicon and oxygen content decreases and the carbon content increases towards the surface of the coating.

14. A craze resistant plastic article according to claim 1, wherein the coating has a thickness of about 500 nm to about 10,000 nm.

15. (canceled)

16. A craze resistant plastic article according to claim 1, wherein the coating is overcoated with a topcoat.

17. A craze resistant plastic article according to claim 16, wherein the topcoat is selected from the group consisting of hydrophobic topcoats, oleophobic topcoats, hydrophilic topcoats, diamond like carbon topcoats, metal oxide topcoats, and slippery topcoats.

18. A craze resistant plastic article according to claim 17, wherein the topcoat is a fluoropolymer.

19. A craze resistant plastic article according to claim 1, wherein the substrate is selected from the list including acrylic, stretched acrylic, polystyrene, polycarbonate, polyethylene-terephthalate, polyvinylchloride, and polyamide.

20. (canceled)

21. A craze resistant plastic article according to claim 1, wherein the article is an aircraft window.

22. A process for producing a craze resistant plastic article, the process including:
providing a plastic substrate suitable for coating;
activating a surface of the substrate;
exposing the substrate surface to a plasma gas formed by introducing a gas mixture containing oxygen and an organosilicon monomer into a plasma chamber to deposit a polymer coating that adheres to the surface of the substrate, wherein an innermost region of the coating adjacent the surface of the substrate is deposited with a ratio of organosilicon monomer to oxygen in the gas mixture that is greater than or equal to 1, and an outermost region of the coating is deposited with a ratio of organosilicon monomer to oxygen in the gas mixture that is less than 1; and
the ratio of organosilicon monomer to oxygen in the plasma gas is altered progressively over time between deposition of the innermost and outermost regions to form a graded coating.

23. A process for producing a craze resistant plastic article according to claim 22, wherein the step of activating the surface includes a step of pre-treating the surface of the substrate with a lower alcohol, preferably using a plasma deposition step.

24. (canceled)

25. (canceled)

26. A process for producing a craze resistant plastic article according to claim 22, wherein the process is carried out using a plasma that is activated by microwaves.

27. A process for producing a craze resistant plastic article according to claim 22, wherein the organosilicon monomer is a hexa- or tetra-alkylorganosilane containing alkyl groups having between 1 and 10 carbon atoms.

28. A process for producing a craze resistant plastic article according to claim 27, wherein the organosilicon monomer is selected from the list consisting of tetramethyldisiloxane, hexamethyldisiloxane, tetrapropoxysilane, tetraethoxysilane, tetramethoxysilane and vinyltrimethylsiloxane.

29. (canceled)

30. A process for producing a craze resistant plastic article according to claim 22, wherein the coating is produced using plasma deposition conditions with a constant organosilicon monomer gas flow rate of 150 sccm and an oxygen gas flow rate of 100 sccm during deposition of the innermost region of the coating and an oxygen gas flow rate of 500 sccm during deposition of the outermost region of the coating.

31. A process for producing a craze resistant plastic article according to claim 30, further including a step of depositing a middle region with an oxygen gas flow rate of 300 sccm during deposition of the middle region of the coating.

32. A process for producing a craze resistant plastic article according to claim 22, wherein the substrate temperature is kept between 40° C. and 100° C. during the deposition process.

33. A process for producing a craze resistant plastic article according to claim 22, wherein the coating is deposited over a period of 60 to 300 seconds.

34. (canceled)

35. (canceled)

36. A process for producing a craze resistant plastic article according to claim 22, further including a step of applying a topcoat over the coating.

37. A process for producing a craze resistant plastic article according to claim 37, wherein the topcoat is selected from the group consisting of a hydrophobic topcoat, an oleophobic topcoat, a hydrophilic topcoat, a diamond like carbon topcoat, a metal oxide topcoat, and a slippery topcoat.

38. A process for producing a craze resistant plastic article according to claim 37, wherein the topcoat is a fluoropolymer layer that is deposited using a perfluorinated compound.

39. (canceled)

40. (canceled)

41. (canceled)

42. A process for producing a craze resistant plastic article according to claim 22, wherein the article is an aircraft window.

43. A process for producing a craze resistant plastic article according to claim 22, wherein the coating has a thickness of about 500 nm to about 10,000 nm.

44. (canceled)

45. A craze resistant coated plastic article that is formed according to the process of claim 22.

46. (canceled)

47. (canceled)

48. (canceled)
